(19) United States
(12) Patent Application Publication
(10) Pub. No.: US 2011/0148650 A1
(43) Pub. Date: Jun. 23, 2011

(54) Mechanical Proximity Sensor Enabled Electromagnetic Service Connector System

(75) Inventors: Anthony E. Jenkins, Stevensville, MI (US); Richard A. McCoy, Stevensville, MI (US)

(73) Assignee: WHIRLPOOL CORPORATION, Benton Harbor, MI (US)

(21) Appl. No.: 12/643,285

(22) Filed: Dec. 21, 2009

(51) Int. Cl. G08B 21/00; H02J 17/00

(52) U.S. Cl. 340/686.6; 307/104

(57) ABSTRACT

An electromagnetic service connector system includes first and second electromagnetic service connector components for communicating an electromagnetic service between an electromagnetic service provider and an electromagnetic service consumer. The electromagnetic service may be any form of electrical power or data. An electromagnetic service switch is provided for selectively transferring the electromagnetic service from the electromagnetic service provider to the electromagnetic service consumer in response to a proximity sensor engaging a proximity target.

### BACKGROUND

Traditionally, appliances, consumer electronics devices, and other useful household equipment are located in a room dedicated to the function supported by the appliance, consumer electronic device, and/or household equipment. For example, the kitchen has traditionally been limited to a space for preparing and eating meals and consequently has mostly been occupied by cabinetry and large home appliances such as refrigerators, dishwashers, and ovens. The family room has been designated as a place for leisure activities, and so most entertainment devices, such as televisions and video games are commonly found here. Laundry rooms normally house a washer, dryer, and iron. Devices such as personal computers and printers are often located in another room, such as a dedicated home office or bedroom.

Consumers increasingly own multiple hand-held or portable consumer electronic devices, such as laptops, cell phones, PDA's, and digital music players. These devices are typically used in many different rooms in the house and are often carried from room to room throughout the home. Consumers also tend to perform nontraditional tasks in the traditional rooms of the home. For example, consumers also tend to eat in the living room or media room, instead of the dining room. Consumers tend to eat, meet and entertain in the kitchen, not just in the dining room and family room. In fact, the kitchen is often the hub of most household activity. Consumers also tend to work in every room of the home with the adoption of laptop computers and wireless networks. Therefore, there is a trend for consumers to perform non-traditional functions in a household room designed for a traditional function. The present invention recognizes this trend and attempts to support the trend.

### BRIEF SUMMARY

The present disclosure relates to electromagnetic service connector systems for connecting accessory devices to a host.

According to one aspect of the invention, a system for communicating between an electromagnetic service provider and an electromagnetic service consumer comprises an electromagnetic service connector system. The system comprises a first electromagnetic service connector component capable of being operably associated with the electromagnetic service consumer and including a proximity target, a second electromagnetic service connector component operably engageable with the first electromagnetic service connector component, the second electromagnetic service connector component being capable of being operably associated with the electromagnetic service provider, an electromagnetic service switch operably associated with the second electromagnetic service connector component, the electromagnetic service switch selectively permitting the flow of the electromagnetic service from the electromagnetic service provider to the first electromagnetic service connector component, and a proximity sensor operably associated with the electromagnetic service switch, the proximity sensor engageable with the proximity target when the first electromagnetic service connector component is engaged with the second electromagnetic service connector component, wherein the electromagnetic service switch is operable to permit flow of the electromagnetic service to the first electromagnetic service connector component in response to the proximity sensor engaging the proximity target.

According to another aspect of the invention, an electromagnetic service connector system for connecting electromagnetic service communicating devices comprises an electromagnetic service connector component capable of communicating an electromagnetic service, an electromagnetic service switch operably connected to the electromagnetic service connector component for selectively permitting the electromagnetic service to be transmitted to the electromagnetic service connector component, and a proximity sensor operably connected to the electromagnetic service switch and engageable with a proximity target, wherein the electromagnetic service switch is configured to allow the electromagnetic service to be transmitted to the electromagnetic service connector component when the proximity sensor engages the proximity target.

According to yet another aspect of the invention, a system is used in association with a host having an electromagnetic service provider, a first electromagnetic service connector component, and an electromagnetic service switch selectively providing an electromagnetic service to the first electromagnetic service connector component, and in association with an electromagnetic service consumer. The system comprises a second electromagnetic service connector component engageable with the first electromagnetic service connector component, an electromagnetic service line interconnecting the electromagnetic service consumer and the second electromagnetic service connector component, and a proximity target capable of engaging a proximity sensor to activate the electromagnetic service switch to provide an electromagnetic service to the first electromagnetic service connector component.

According to still another aspect of the invention, an adapter removably couples a first electromagnetic service communicating device having a first device electromagnetic service connector component to a second electromagnetic service communicating device having a first host electromagnetic service connector component that cannot be directly connected to the first device electromagnetic service connector component, and a first contact proximity coupling device. The adapter comprises a second host electromagnetic service connector component engageable with the first host electromagnetic service connector component, a second device electromagnetic service connector component engageable with the first device electromagnetic service connector component, an electromagnetic service line for the transfer of an electromagnetic service between the second host electromagnetic service connector component and the second device electromagnetic service connector component, and a second contact proximity coupling device operably associated with the second host electromagnetic connector component, the second contact proximity coupling device being configured to engage the first contact proximity coupling device when the first and second electromagnetic connector components are engaged to selectively permit the communication of the electromagnetic service between the first electromagnetic communicating device and the second electromagnetic service communicating device.

### BRIEF DESCRIPTION OF THE DRAWINGS

In the drawings:

FIG. 1 is a perspective view of a modular system according to a first embodiment of the invention employing a mechanically energized electromagnetic service connector system for connecting an accessory device to a host.

FIG. 2 is a front elevational view of the modular system of FIG. 1, showing the accessory device attached to the host.

FIG. 3 is a side elevational view of the modular system of FIG. 1, showing the accessory device removed from the host.

FIG. 4 is partial top rear perspective view of the modular system of FIG. 1 with the accessory device removed from the host, showing a host portion of the mechanically energized electromagnetic service connector system, with portions shown schematically.

FIG. 5 is a bottom perspective view of the accessory device of FIG. 1, showing an accessory device portion of the mechanically energized electromagnetic service connector system.

FIG. 6 is a partial cross-sectional view of the mechanically energized electromagnetic service connector system of FIG. 1, showing the accessory device portion of the electromagnetic service connector system positioned for engagement with the host portion of the electromagnetic service connector system.

FIG. 7 is a partial cross-sectional view similar to FIG. 6, showing the accessory device portion of the electromagnetic service connector system engaged with the host portion of the electromagnetic service connector system.

FIG. 8 is a partial cross-sectional view of a modular system according to a second embodiment of the invention employing a switched electromagnetic service connector system, showing an accessory device portion of the electromagnetic service connector system positioned for engagement with a host portion of the electromagnetic service connector system.

FIG. 9 is a partial cross-sectional view similar to FIG. 8, showing the accessory device portion of the electromagnetic service connector system engaged with the host portion of the electromagnetic service connector system.

FIG. 10 is a generalized schematic illustration showing an electromagnetic service supply and consumption system.

### DETAILED DESCRIPTION

Referring now to the discussion that follows and to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or to otherwise limit or restrict the claims to the precise forms and configurations shown in the drawings and disclosed in the following detailed description.

The drawings and the following description relate generally to electromagnetic service connector systems for coupling an electromagnetic service provider with an electromagnetic service consumer. The following definitions apply to terms that may be used in the specification and the claims, unless otherwise noted.

As used herein, an “electromagnetic service” is electrical power or data. An electromagnetic service may comprise multiple categories of service, such as electrical power and data in a single signal. An electromagnetic service may be provided continuously, for specified times, for specified amounts, or for the duration of certain events, such as the duration of coupling to provide timed dispensing. Alternatively, an electromagnetic service may be provided in quanta, such as packets of data.

The term “coupled” and any variation thereof, as used herein, includes any type of connection that permits transfer of a service, as hereinafter defined, between two devices. The term “coupled” does not require a physical connection between the two devices so long as the coupling permits transfer of a service. The term “coupled” includes both fixed and removable coupling, as well as both continuous and intermittent coupling.

“Wireless” refers to a type of communication in which power and/or data is transferred over a distance without the use of electrical conductors or wires. For example, electromagnetic waves, light waves, or acoustic waves can be used to carry power and/or data over a distance without using electrical conductors or wires.

“Electrical power communication” is the coupling of two devices to supply electrical power from at least one of the devices to the other of the devices, such as through directly connected electronic lines or through wireless power communication (also referred to as wireless power transmission). Wireless power communication may include any type of wireless power communication, including, without limitation for illustration purposes, microwave transmission, laser transmission, and magnetic fields. Exemplary categories of power communication include the type of power, e.g. alternating current (also known as AC) or direct current (also known as DC), supplied to a functional device (defined below) and variations in the characteristics of the power, such as the voltage or current.

“Data communication” is the coupling of two devices to transmit data from at least one of the devices to the other of the devices, such as through directly connected electronic lines or through wireless data communication (also referred to as wireless data transmission). The data may be transmitted as a separate signal or embedded in electrical power communication. Wireless data communication may include any type of wireless data communication, including, without limitation for illustration purposes, wireless network (a/k/a Wi-Fi), radio transmission, light transmission, and acoustical transmission. Exemplary categories of data communication include encrypted and unencrypted data. Data communication also includes communication for different protocols, including physical layer protocols and software layer protocols. Examples of physical layer protocols are a wired Ethernet and a wireless (Wi-Fi) network, both of which may support the same data packet structure. Examples of software layer protocol are Zigbee® and Bluetooth®. Data communication may also be completed by way of an analog mechanical transmission means such as by means of fluidic pulses created by positive pressure systems or vacuum systems or by a mechanical logic transfer means, such as the throwing of switches or levers to actuate or transmit information about a control state.

“Communicating” an electromagnetic service, and any variation thereof, as used herein, means supplying or receiving an electromagnetic service. As used herein, communication of electromagnetic service includes both uni-directional and multi-directional communication between any two devices, either directly or through an adapter, as defined herein.

The terms “provide” and “supply” and any variation thereof, are used herein to denote a source of the electromagnetic service relative to a device receiving the electromagnetic service. Neither term is limited to the original source of the electromagnetic service. A device that provides or supplies the electromagnetic service may simply be passing on the electromagnetic service from the original source, such as a residential power utility system or the internet. For example, a device that provides an electrical power service may pass on electricity it receives from a household outlet. However, the device may, alternatively or additionally, provide another electromagnetic service that originates with the device, such as a data service.

The term “receive” and any variation thereof, is used herein to denote receipt of the electromagnetic service relative to the device providing the electromagnetic service. The term is not limited to the ultimate consumer of the service. A device that receives the electromagnetic service may simply be passing on the electromagnetic service from the source, such as an appliance, to a device that will consume, as hereinafter defined, the electromagnetic service. The device that receives an electromagnetic service is not necessarily the end consumer of the electromagnetic service.

The term “consume” and any variation thereof, as used herein, denotes the act of employing or dispensing at least a portion of the electromagnetic service received in connection with performing a function, such as using a power service to operate a speaker or video display.

A “useful device” as used herein is a device that is capable of performing a useful physical or virtual function either alone or in combination with another device.

An “electromagnetic service consumer” as used herein is any useful device that employs, uses, stores, or dispenses an electromagnetic service in connection with performing a physical or virtual function. An electromagnetic service consumer may be, for example, a consumer electronic device, a client software device, a remote user interface, a source of consumer information, a reader, such as a bar code, optical scanner or RFID reader, a sensor device, a smart utensil, an appliance, an additional smart coupling device, a remote controller, a network binder, a cycle accessory, a resource controller, such as an energy controller, a communicator, such as an audible accessory, an access or payment system, such as a smart card system permitting access to a host device, a sales demonstration device, an electromagnetic service holder, such as a battery, a dispenser, a media content holder, or an electromagnetic service device, such as a laptop or other service client.

An “electromagnetic service provider” as used herein is any useful device that is capable of providing or supplying an electromagnetic service to another device.

An “electromagnetic service communicating device” as used herein is any useful device that is capable of communicating an electromagnetic service with another device, and may be an electromagnetic service provider or an electromagnetic service consumer.

A “host” as used herein is an electromagnetic service provider that has a primary function independent of providing an electromagnetic service. For example, the host may be an appliance and the primary function may be performing a series of steps to conduct a useful cycle of operation. The appliance may be a conventional household appliance, such as a refrigerator performing a cooling cycle or an ice making cycle. Other examples of appliances that may be hosts include, but are not limited to, a freezer, a conventional oven, a microwave oven, a dishwashing machine, a stove, a range, an air conditioner, a dehumidifier, a clothes washing machine, a clothes dryer, a clothes refreshing machine, and a non-aqueous washing apparatus, or any combination thereof. Alternatively, the host may be a fixture such as a water softener, a water heater, a furnace, pool water treatment equipment, or an HVAC system. The host may be a small device such as a thermostat, a blender, a mixer, a toaster, a coffee maker, an air purifier, an iron, a vacuum cleaner, a robot, or a trash compactor. The host may alternatively comprise a structural feature of a building, such as a wall, a cabinet, or a door. The host may also provide other services, such as mechanical power, illumination, heat, or sound. The host may be an electromagnetic service consumer. For example, a host may provide a power service while receiving or while receiving and supplying a data service.

A “functional device” as used herein may be an electromagnetic service provider, an electromagnetic service consumer, or both.

As used herein, the terms “accessory” or “accessory device” refer to any useful device that may be used primarily in conjunction with a host to enhance, supplement, regulate or monitor the functionality of the host. An accessory device may be a service provider, a service consumer, or both. Examples of an accessory device include, but are not limited to, a television, a video camera, a video recorder, a personal computer, a notebook computer, a computer monitor, a video display, a keyboard, a printer, copying equipment, a calculator, a facsimile machine, a scanner, a digital storage device, a wireless transceiver, an internet router, a power supply, a data recorder, an answering machine, a telephone, a cordless telephone, a cellular telephone, a video game system, a personal digital assistant, a DVD player, a VHS player, a VCR, a cassette deck, an 8 mm video player, a CD player, a Blackberry®, a smartphone, a smoke detector, a portable digital video player, an MP3 player, a radio, other music players, an audio speaker, a digital picture frame, a weather station, and a scale or balance.

A “portable device” as used herein is a device that is designed to be moveable by a user during its useful life between a use location and a storage location or alternative use location. A portable device can be an accessory device.

An “independent device” as used herein is a useful device that provides a useful function without being connected to a service provider. In some cases, the primary function of the independent device is different from the primary function of the host from which the independent device may receive a service. The independent device may be a consumer electronic device, such as portable communication, entertainment, informational or educational devices.

A “dependent device” as used herein is a useful device that provides a useful function only when connected to a service provider. A dependent device may be a service consumer. Examples of dependent service consumers that may be coupled to a host include a remote user interface (UI), a consumable reader, a cooking sensor, a smart pan or pot, a smart dimmer, a cycle accessory, an energy controller, an audible accessory, a laundry payment or smart card system, a sales demonstration unit, or a service laptop or other service client.

An “electromagnetic service connector system” as used herein is a connector system having at least two separate electromagnetic service connector components, each associated with a useful device. The electromagnetic service connector components cooperate with one another to couple the useful devices to facilitate communication of an electromagnetic service between the useful devices. An electromagnetic service connector system may carry multiple services.

A “plug” as used herein is a generally male electromagnetic service connection component.

A “receptacle” as used herein is a generally female electromagnetic service connection component.

A “switched electromagnetic service connector system” as used herein is an electromagnetic service connector system having a switching capability in at least one of the electromagnetic service connector components operable to selectively permit the communication of an electromagnetic service between the components of the electromagnetic service connector system. Since a service connector system may carry multiple services, a switched electromagnetic service connector system may selectively permit the communication of different services.

An “electromagnetic service switch” as used herein is a switch that selectively responds to the detection of a proximity target, defined below, being within a predetermined distance of a proximity sensor. In response to the detection, the electromagnetic service switch regulates the provision of an electromagnetic service and selectively facilitates the communication of an electromagnetic service between components of an electromagnetic service connector system, such as by drawing the components into engagement or by permitting the flow of an electromagnetic service to one of the components for transfer to the other of the components. An electromagnetic service switch may be associated with more than one type of service.

As used herein, an “electromagnetic service line” or “electromagnetic service pathway” is a pathway for transferring an electromagnetic service from one location to another. The electromagnetic service line may have any of a variety of configurations, including, but not limited to, a pipe, a conduit, a wire, a tube, a channel, and a fiber optic cable. More particularly, to transfer electrical power or data, an electromagnetic service line may include an electrically conductive wire, an optical data cable, or a wireless transmission system.

A “proximity target” as used herein is any component or device that may be detected when positioned within a predetermined distance of an associated proximity sensor, defined below. A proximity target may be passive, such as a visual target or a magnetic target formed of magnetic or magnetic responsive material. Other examples of passive proximity targets may include a conductive component or surface capable of cooperating with a magnetic field, a current, or a voltage provided by a proximity sensor. A proximity target may alternatively be active or powered such as an electromagnet, a generator of a magnetic field, a current, a voltage or an acoustic wave. An active proximity target may alternatively provide a powered readable display or dispense a detectable chemical.

A “proximity sensor” as used herein is any component or device that may detect an associated proximity target when the proximity target is within a predetermined distance of the proximity sensor. A proximity sensor may detect, for example, a change in an electromagnetic field, an electromagnetic wave, an acoustic wave, a visual target, a chemical component, an electrical signal, a change in voltage, a change in current, a change in frequency, a change in resistance, a change in inductance, a change in capacitance, a mechanical signal, a change in pressure, a displacement, a vibration, and the presence of a chemical. A proximity sensor may be active or passive, such as a magnetic sensor of magnetic or magnet responsive material, or may alternatively be active. Examples of active sensors include active magnetic sensors, light sensors, optical sensors, acoustic sensors, electromagnetic sensors, chemical sensors and thermal sensors. Examples of magnetic sensors include magnets and magnetic responsive components. Examples of optical sensors include infrared sensors, photoelectric sensors, fiber optic sensors, photo resistors, photovoltaic sensors, photo diodes and cameras. Examples of electromagnetic sensors include radio receivers, radar sensors, Hall Effect sensors, inductive sensors, capacitive sensors, variable reluctance sensors and eddy current sensors. Examples of acoustic sensors include ultrasonic sensors and microphones. A contact proximity sensor detects a proximity target by touching the proximity target. A contactless proximity sensor detects the proximity target through a wireless or contactless means. For example, magnetic flux can be used as the signaling mechanism between a contactless proximity sensor and a contactless proximity target.

As used herein, the term “proximity system” is a system that uses a “proximity switch” operated by a plurality of “proximity coupling components,” each associated with a different parent device, for determining that the parent devices are in proximity with each other. Parent devices are usually paired, examples of which include a service provide and a service consumer, a host and an accessory device, and a host and an adapter. Proximity coupling components may include a proximity target associated with one parent device to actively or passively provide an indication of the presence of the one parent device and a proximity sensor associated with the other parent device, responsive to the presence of the proximity target to activate the proximity switch. The proximity switch may be used to provide a signal or message indicative of the proximity of two parent devices or may directly or indirectly regulate the flow of a service along a service line. The proximity systems disclosed herein employ contact proximity systems, wherein the proximity target and proximity sensor use physical contact to detect the proximity of the two parent devices.

An “adapter” as used herein is an intermediate device that may be provided between a first and second useful device, such as between a host and an accessory, to facilitate the communication of services between the first and second useful devices. An adapter may receive an electromagnetic service from the first useful device and provide a modified version of the electromagnetic service to the second useful device, for example, by providing an electrical power service using a different voltage or providing a data service using a different data structure or signal type. In some applications, multiple adapters may be interposed between two useful devices. In other applications, three or more useful devices may be coupled to a single adapter, such as between a host and two accessories. In some applications, the adapter may itself be a functional device providing a useful function not provided by the useful devices coupled to it. An adapter may optionally include a transformative component that transforms a service from a service provider to a different service, which is supplied to a service consumer. This may be useful when the service from the service provider is not compatible with the service consumer. The transformative component can be configured to transform the service into a compatible form for the service consumer. Examples of transformative components are protocol converters, power transformers, or other devices that convert substance, energy, or data from a first form to a second form.

A “functional unit” as used herein is any adapter coupled to a useful device, which together provide a functionality that neither the adapter nor the useful device may alone provide. Any functional unit itself is also included within the meaning of the term “useful device”. In some cases, it is contemplated that a dependent device may be coupled with an adapter that provides one or more services required by the dependent device to enable the functional unit to provide a useful function, in which case the functional unit also constitutes an independent device.

A “storage device” as used herein is any device capable of receiving a service, storing the service, and selectively dispensing the service. A storage device may include, for example, s battery, a capacitor, a hard disk drive, an optical disc, such as CD, DVD, or Blue-ray Disc, a floppy disk, a ZIP disk, a minidisk, a solid state semiconductor memory, such as xD-Picture card, a MultiMediaCard, a USB flash drive, SmartMedia, an SD card, a miniSD card, an SDHC card, a microSD card, a TransFlash card, a CompactFlash I or II, a Secure Digital, or a Sony Memory Stick.

A “conversion device” as used herein is any device capable of converting the form of an electromagnetic service, or converting one electromagnetic service to another service. Examples of a conversion device include, but are not limited to, a generator, a motor, a piezoelectric device, a pneumatic device, an inverter, a lens, a filter, a prism, a transmitter, a speaker, and a resonator.

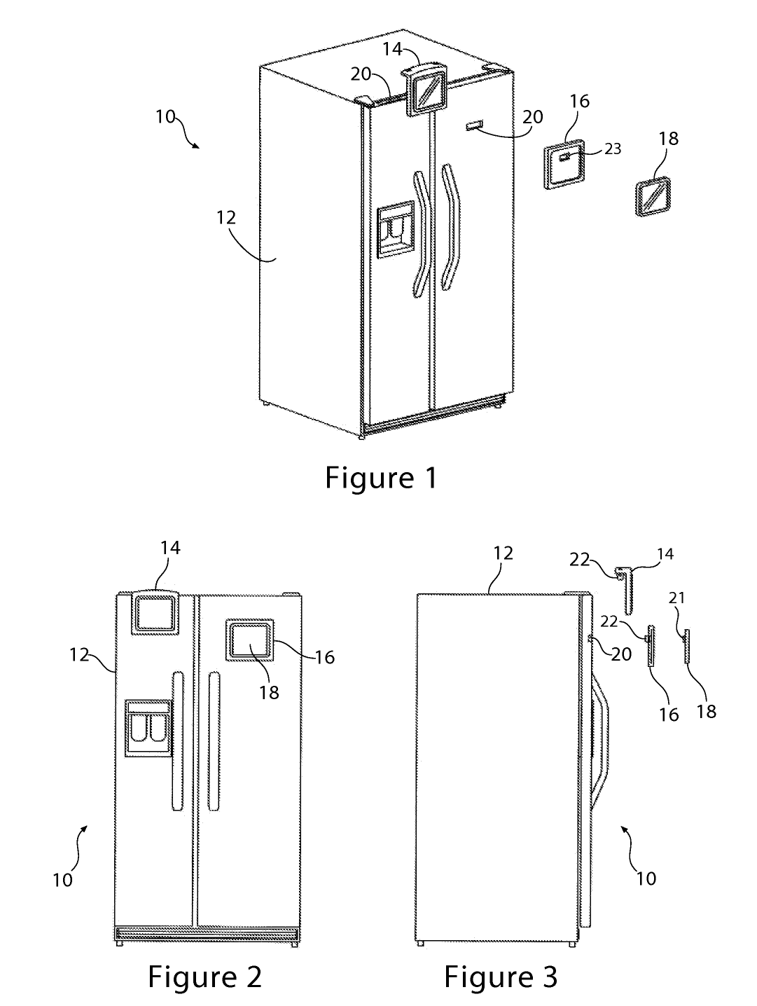

Referring now to FIGS. 1-3, a schematic illustration of a modular system 10 according to one embodiment of the invention is shown to include at least two electromagnetic service communicating devices. As illustrated herein, one electromagnetic service communicating device is a host 12 and the other electromagnetic service communicating device is an accessory device 14 that may be coupled to host 12. Further, the host may be an electromagnetic service provider and the accessory device 14 may be an electromagnetic service consumer.

The accessory device 14 may be either directly or indirectly coupled to host 12. Direct coupling occurs when accessory device 14 includes an electromagnetic service connector component suitably configured for engaging a corresponding electromagnetic service connector component of host 12 to establish an electromagnetic service pathway between the host 12 and the accessory device 14. The electromagnetic service pathway provides a conduit for transferring at least one electromagnetic service from host 12 to accessory device 14 and from accessory device 14 to host 12.

An adapter 16 may be provided for coupling a second accessory device 18 having an incompatible electromagnetic service connector component to host 12. An electromagnetic service connector component is incompatible if it cannot be directly coupled to a corresponding electromagnetic service connector component, such as when the incompatible electromagnetic service connector component lacks certain physical features that would enable the electromagnetic service connector component to engage the corresponding connector component to establish an electromagnetic service pathway. Adapter 16 may include an electromagnetic service connector component that may be directly coupled with the electromagnetic service connector component of host 12 and a second electromagnetic service connector component that may be directly coupled with the incompatible electromagnetic service connector component of accessory device 18, thereby establishing an electromagnetic service pathway between host 12 and accessory device 18.

Although accessory device 14 is shown coupled to an upper surface of host 12, whereas accessory device 18 is shown attached to a front surface of host 12 by way of adapter 16, it shall be appreciated that in practice, accessory device 14 and adapter 16 may be suitably configured for coupling to host 12 in any desired location and manner in order to accommodate the design and performance requirements of a particular application.

Host 12 may perform a primary function. As illustrated herein, host 12 is a refrigerator performing a cooling cycle and/or an ice making cycle. Although the figures show an appliance comprising a refrigerator, it shall be understood that the invention is not limited to refrigerators or appliances in general.

Accessory devices 14 and 18 may also perform at least one primary function. The primary functions of accessory devices 14 and 18 can be different from the primary function performed by host 12, although they need not be.

Host 12 may be configured to provide or receive at least one electromagnetic service to or from accessory devices 14 and 18. Similarly, accessory devices 14 and 18 may also be configured to provide or receive at least one electromagnetic service to or from host 12. It is not necessary that the electromagnetic service transferred between host 12 and accessory devices 14 and 18 be used in performing the primary function of host 12 or accessory devices 14 and 18, or otherwise be related to the primary function of either accessory device.

As mentioned previously, in instances where the accessory device includes an incompatible electromagnetic service connector component that prevents direct coupling of the accessory device to host 12, adapter 16 may be provided for indirectly coupling the accessory device to host 12. Adapter 16 operates to establish an electromagnetic service pathway for transferring the desired electromagnetic service between host 12 and accessory device 18 having the incompatible electromagnetic service connector component.

At least one electromagnetic service may be supplied to accessory devices 14 and 18 from host 12, or from accessory devices 14 and 18 to host 12. The supply of the electromagnetic service may be uni-directional in that either host 12 supplies the electromagnetic service to accessory devices 14 and 18 or accessory devices 14 and 18 supply the electromagnetic service to host 12. The supply of the electromagnetic service may also be bi-directional in that the supplied electromagnetic service may be delivered from host 12 to accessory devices 14 and 18 and from accessory devices 14 and 18 to host 12.

Electromagnetic services that may be transferred between host 12 and accessory devices 14 and 18 may include electrical energy and data communication, among others. Data communication may include the transfer of information by way of appropriate transfer media including but not limited to electrical, electromagnetic wave, acoustic, and optical data between host 12 and accessory device 14. For example, host 12 may include a modem for enabling internet access to the World Wide Web. Accessory device 14 may also include an electronic device, such as a computer, PDA, digital music player, among others, which when coupled to host 12 may access various forms of data available from the World Wide Web through the modem and have the data transferred from host 12 to accessory device 14. Electrical energy may include electric current such as both alternating current, and direct current, or both. Electric current may, for example, be transferred from host 12 to accessory device 14 for powering the accessory device 14. It is not necessary that host 12 be the source of the electric current. Host 12 may be operating as a conduit for transferring electric current received from an outside source, such as a residential power service or an internet service provider. It will be appreciated that these are only a few examples of the various types of electromagnetic services that may be transferred between host 12 and accessory devices 14 and 18.

It will further be appreciated that, while the embodiments in the drawings illustrate specific types of electromagnetic service communicating devices, such as a host 12 that may operate as an electromagnetic service provider, an accessory device 14 that may operate as an electromagnetic service consumer, and an adapter 16 that may act as a conduit for the transfer of electromagnetic service from host 12 to accessory device 18, variations from this configuration are possible. These variations include systems with only two electromagnetic service communicating devices, systems with more than three electromagnetic service communicating devices, systems where any of the devices may be service consumers and/or service providers, systems where multiple services are communicated and systems where services are received by one device, converted in some manner, and then passed to a third device. Furthermore, in the following description, certain components of connector systems and proximity systems are described for the illustrative purposes as being associated with specific exemplary electromagnetic service communicating devices. For example, a proximity switch, target or sensor may be described as being located in a service provider, service consumer, host or portable device. It will be appreciated that these system components may be alternatively assigned to the various electromagnetic service communicating devices depending on the application.

Host 12 and accessory device 14 may each comprise at least one electromagnetic service connector component, respectively referred to herein as a host electromagnetic service connector component 20 and a device electromagnetic service connector component 22. Host electromagnetic service connector component 20 and device electromagnetic service connector component 22 have complementary configurations that enable the electromagnetic service connector components to be coupled to one another, thereby establishing an electromagnetic service pathway over which desired electromagnetic services may be transferred between host 12 and accessory device 14.

Host 12 also has a second host electromagnetic service connector component 20 provided on its front surface for coupling with a first device electromagnetic service connector component 22 provided on the adapter 16. In instances where the accessory device 18 includes an incompatible electromagnetic service connector component, and the adapter 16 is used as an intermediate component to connect accessory device 18 to host 12, then adapter 16 may include a second device electromagnetic service connector component 23 for engagement with a device electromagnetic service connector component 21 of accessory device 18, as well as the first device electromagnetic service connector component 22 for connection with the host electromagnetic service connector component 20 of host 12. Therefore, device electromagnetic service connector component 22 may have the same general configuration whether included as part of accessory device 14 or adapter 16, and host electromagnetic service connector component 20 may have the same general configuration whether it couples directly with accessory device 14 or adapter 16. Accordingly, for purposes of discussion, the various features and operation of electromagnetic service connector components 20 and 22 will hereinafter be described in connection with host 12 and accessory device 14, but it shall be appreciated that the connector components may also be used in conjunction with adapter 16.

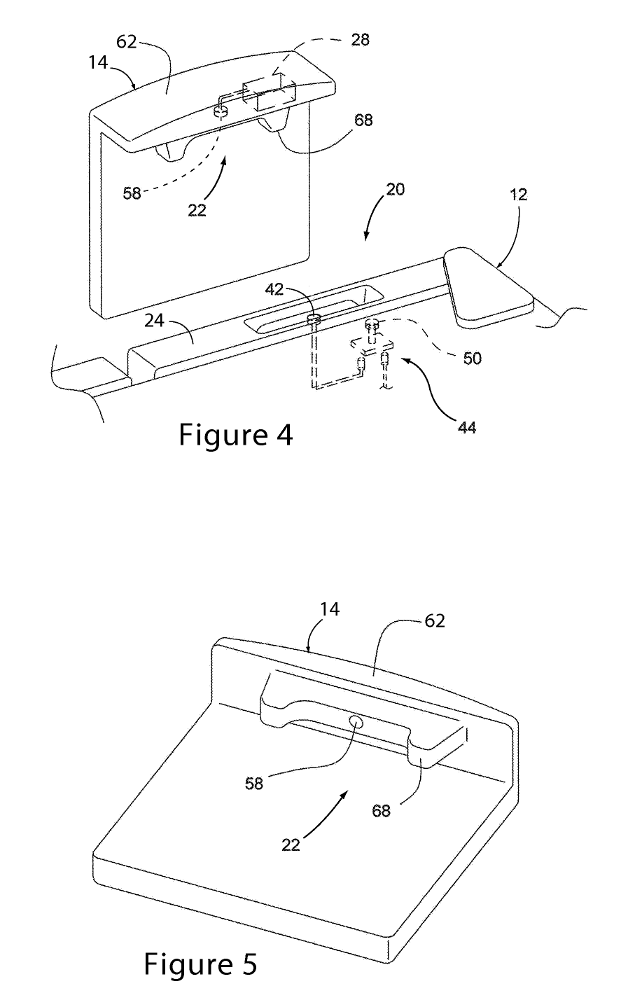

Referring to FIGS. 4 and 5, host electromagnetic service connector component 20 may be integrally formed with host 12 or may be an add-on device. Host electromagnetic service connector component 20 may be enclosed within a housing 24. Housing 24 may be an integral part of host 12 or may be a separate component. For purposes of discussion, housing 24 is illustrated as an integral part of host 12. When configured as an add-on device, host electromagnetic service connector component 20 may also function as an adapter to enable a host and an accessory device having dissimilar electromagnetic service connector components to be indirectly coupled to one another. Host electromagnetic service connector component 20 may be removable or non-removable from host 12. Host electromagnetic service connector component 20 may be configured to transfer or receive a single electromagnetic service or multiple electromagnetic services.

Device electromagnetic service connector component 22 may be integrally formed with accessory device 14 or may be an add-on component. When configured as an add-on component, device electromagnetic service connector component 22 may also function as an adapter to enable a host and an accessory device having dissimilar electromagnetic service connector components to be indirectly coupled to one another. Device electromagnetic service connector component 22 may be removable or non-removable from accessory device 14. Device electromagnetic service connector component 22 may be configured to transfer or receive a single electromagnetic service or multiple electromagnetic services.

For purposes of discussion, device electromagnetic service connector component 22 is shown integrally formed with accessory device 14. Device electromagnetic service connector component 22 may be enclosed within a housing 62. Housing 62 may be an integral part of accessory device 14 or may be a separate component. For purposes of discussion, housing 62 is illustrated as an integral part of accessory device 14.

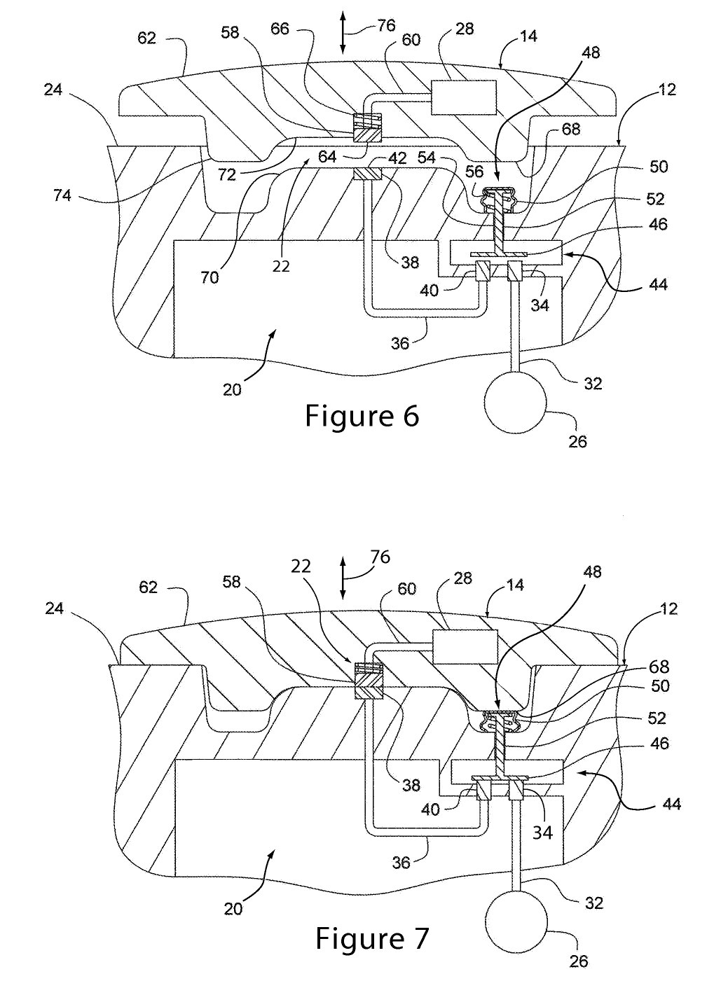

Referring to FIGS. 6 and 7, host 12 may be associated with an electromagnetic service provider 26 for selectively providing an electromagnetic service to host electromagnetic service connector component 20 for delivery to device electromagnetic service connector component 22. Accessory device 14 may similarly be provided with an electromagnetic service consumer 28 capable of using the electromagnetic service delivered to device electromagnetic service connector component 22.

Host electromagnetic service connector component 20 may include a first host electromagnetic service line 32 operably connected to electromagnetic service provider 26. First host electromagnetic service line 32 is operable for transferring an electromagnetic service from electromagnetic service provider 26 for delivery to accessory device 14. First host electromagnetic service line 32 terminates at a first terminal 34.

Host electromagnetic service connector component 20 may further include a second host electromagnetic service line 36 having one end operably connected to a host interface 38 and an opposite end to a second terminal 40. Host interface 38 extends through housing 24 to be accessible from outside the housing 24. An exposed end 42 of host interface 38 operably engages a corresponding interface of accessory device 14 when accessory device 14 is coupled to host 12. It will be appreciated that host interface 38 may be configured as one or more electrical contacts, a fiber optic cable, or another type of interface, depending on the electromagnetic service being provided by electromagnetic service provider 26.

Host electromagnetic service connector component 20 may include an electromagnetic service switch 44 that may be selectively actuated to establish an electromagnetic service pathway between first terminal 34 of first host electromagnetic service line 32 and second terminal 40 of second host electromagnetic service line 36 when accessory device 14 is coupled to host 12. Electromagnetic service switch 44 may include a switch plate 46 that is movable between an open position (see FIG. 6) and closed position (see FIG. 7) to enable an electromagnetic service to be selectively transferred between first host electromagnetic service line 32 and second host electromagnetic service line 36 by selectively connecting first terminal 34 to second terminal 40. Although shown generically as a plate-like structure, it shall be appreciated that switch plate 46 may be configured as one or more electrical conductors, tubes, cables, or another type of electromagnetic service pathway consistent with the electromagnetic service being provided by electromagnetic service provider 26. Electromagnetic service switch 44 is generally disposed in the open position when accessory device 14 is decoupled from host 12, as shown in FIG. 6.

The operation of electromagnetic service switch 44, and more particularly, switch plate 46, may be controlled by a mechanically actuated proximity switch 48. Proximity switch 48 may include a proximity sensor 50 adapted to activate electromagnetic service switch 44 to selectively permit the flow of an electromagnetic service from first host electromagnetic service line 32 to second host electromagnetic service line 36 upon engaging an appropriate proximity target associated with accessory device 14.

Proximity sensor 50 may have any of a variety of configurations depending on the requirements of the particular application. An example of one such configuration is illustrated in FIGS. 6 through 9, and may include a moveable plunger 52 that slidably engages an aperture 54 in housing 24. One end of plunger 52 may be operably connected to switch plate 46 and an opposite end extends out from housing 24 and is engagable with a proximity target associated with accessory device 14. Depressing plunger 52 causes switch plate 46 to be displaced toward and into engagement with first and second terminals 34 and 40, thereby allowing an electromagnetic service to pass from first electromagnetic service line 32 to second electromagnetic service line 36. A biasing member 56 may be provided to urge switch plate 46 away from first and second terminals 34 and 40 when the proximity target is not detected by proximity sensor 50.

Electromagnetic service consumer 28 associated with accessory device 14 may be operably connected to an accessory device interface 58 by an accessory device electromagnetic service line 60. Accessory device interface 58 extends through the housing 62 of accessory device 14 so as to be accessible from outside the housing. An exposed end 64 of accessory device interface 58 operably engages host interface 38 of host 12 when accessory device is coupled to host 12. It will be appreciated that accessory device interface 58 may be configured as one or more electrical contacts, a tube, or another type of interface depending on the type of electromagnetic service being consumed by electromagnetic service consumer 28.

Accessory device 14 may further be provided with a biasing member, such as a spring 66, for outwardly biasing accessory device interface 58 from housing 62. Accessory device 14 may further be provided with a proximity target 68 configured for cooperation with the proximity sensor 50.

For purposes of discussion, electromagnetic service lines 32, 36 and 60 are illustrated generically as tube-like structures. The generically illustrated configuration is not intended to depict any particular configuration, but rather schematically represents a variety of potentially different configurations. In practice, the actual configuration will likely vary depending on, at least in part, the type of electromagnetic service being transferred, packaging requirements, and manufacturing considerations. For example, electromagnetic service lines 32, 36 and 60 may be configured as an electrical wire or cable when the electromagnetic service being transported is electric power, or as an electrical wire, electrical cable, or fiber optic cable when the electromagnetic service being transported is electronic data. These, of course, are merely a few examples of the various configurations that first and second host electromagnetic service lines 32, 36 and 60 may include depending on the electromagnetic service involved. Nevertheless, it shall be appreciated that the electromagnetic service lines may include other configurations to accommodate various design considerations, including but not limited to, the type of electromagnetic service being provided.

While proximity switch 48 is illustrated herein as being part of the host 12 and including only the proximity sensor 50, it is understood that the proximity switch 44 could be provided on the accessory device 14, and/or that the proximity sensor 50 and proximity target 68 may together form a proximity switch for determining whether the host 12 and accessory device 14 are in proximity with each other. The proximity switch 48 may be operably connected to the electromagnetic service switch 44 by a link that transmits movement of the proximity switch to the electromagnetic service switch 44. As illustrated herein, the link comprises the plunger 52.

Host electromagnetic service connector component 20 and device electromagnetic service connector component 22 may include various features to facilitate coupling of accessory device 14 to host 12. For example, host electromagnetic service connector component 20 may include a raised boss 70 that may engage a corresponding recess 72 of device electromagnetic service connector component 22. A raised ridge 74 at least partially defines an outer boundary of recess 72. A portion of ridge 74 forms proximity target 68. Alignment features such as boss 70 and recess 72 may assist in positioning device electromagnetic service connector component 22 relative to host electromagnetic service connector component 20 prior to engagement, and may also function to minimizing lateral movement of accessory device 14 relative to host 12 when device electromagnetic service connector component 22 is coupled to host electromagnetic service connector component 20. It will be appreciated, however, that the illustrated configuration is merely one example of the type of features that may be incorporated into host electromagnetic service connector component 20 and device electromagnetic service connector component 22 to aide alignment and coupling of consumer devise 14 to host 12. In practice, other configurations may also be employed to accommodate various design considerations of a particular application.

The process of coupling and decoupling accessory device 14 with host 12 will now be described. Coupling of accessory device 14 to host 12 may be accomplished by positioning accessory device 14 adjacent host 12 in such a manner that device electromagnetic service connector component 22 is generally aligned with host electromagnetic service connector component 20, as shown in FIG. 6. Device electromagnetic service connector component 22 and host electromagnetic service connector component 20 may be coupled by generally moving accessory device 14 toward host 12 along a path indicated by arrow 76 until the two members are fully seated, as shown in FIG. 7. With device electromagnetic service connector component 22 fully engaging host electromagnetic service connector component 20, exposed end 64 of accessory device interface 58 operably engages exposed end 42 of host interface 38. The process of coupling device electromagnetic service connector component 22 to host electromagnetic service connector component 20 causes proximity target 68 to engage proximity sensor 50. Engaging device electromagnetic service connector component 22 with electromagnetic service connector component 20 depresses plunger 52 of proximity switch 48 so as to engage switch plate 46 with first and second terminals 34 and 40, thus allowing the electromagnetic service to pass from electromagnetic service provider 26 to electromagnetic service consumer 28.

Accessory device 14 may be decoupled from host 12 by reversing the previously described process for coupling the two. Disengaging device electromagnetic service connector component 22 from host electromagnetic service connector component 20 releases plunger 52 and disengages switch plate 46 from first and second terminals 34 and 40, thereby interrupting the flow of electromagnetic service between accessory device 14 and host 12 (see FIG. 6).

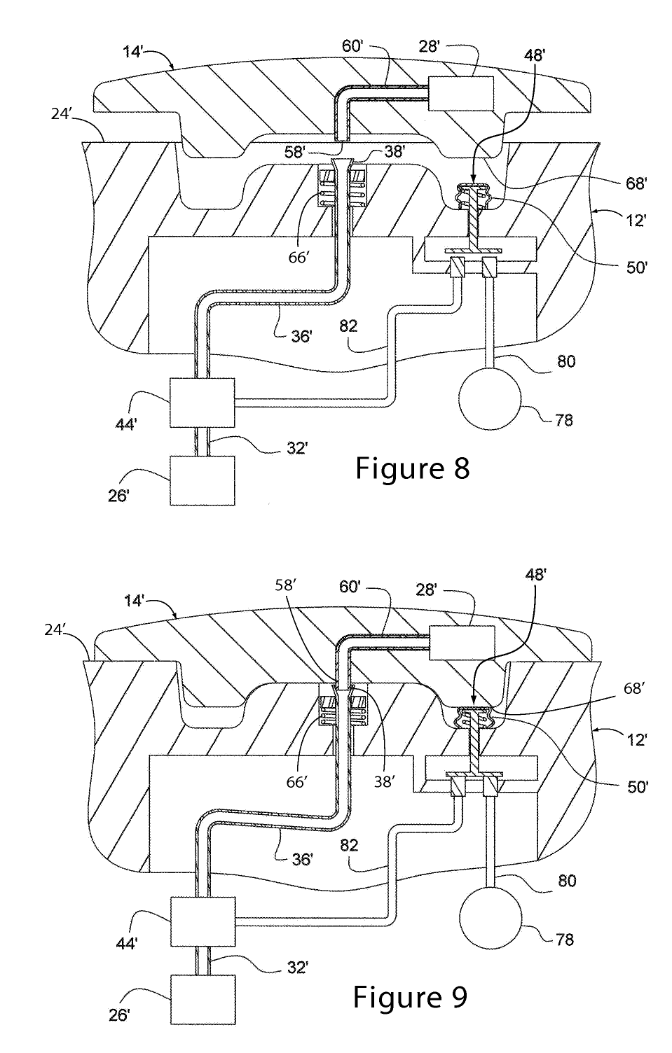

Referring to FIGS. 8 and 9, a second embodiment of a modular system according to the invention is illustrated and comprises a host 12′ and an accessory device 14′, where elements in common with the first embodiment are denoted by the same reference numeral bearing a prime (′) symbol. The modular system includes a switched electromagnetic service connector system employing a proximity switch 48′ for remotely controlling the operation of an electromagnetic service switch 44′. Electromagnetic service switch 44′ selectively controls the transfer of an electromagnetic service from an electromagnetic service provider 26′, associated with a host 12′, to an electromagnetic service consumer 28′, associated with accessory device 14′. Electromagnetic service switch 44′ may have any of a variety of configurations depending on the type of electromagnetic service being transferred. For example, if the electromagnetic service is electrical in nature, such as when providing electrical power or electronic data communication, electromagnetic service switch 44′ may be configured as a mechanical or electronically controlled switch. The precise configuration of electromagnetic service switch 44′ will depend at least in part on the type of electromagnetic service being transferred.

Electromagnetic service switch 44′ may be operably connected to electromagnetic service provider 26′ by means of a first host electromagnetic service line 32′. A second host electromagnetic service line 36′ connects electromagnetic service switch 44′ to a host interface 38′. Host interface 38′ is engagable with a corresponding accessory device interface 58′ when accessory device 14′ is coupled to host 12′. Host 12′ may further be provided with a biasing member, such as a spring 66′, for outwardly biasing host interface 38′ from housing 24′ of host 12′.

Electromagnetic service consumer 28′ may be operably connected to an accessory device electromagnetic service line 60′ that terminates at accessory device interface 58′. Accessory device 14′ may be further provided with a proximity target 68′ chosen for cooperation with a proximity sensor 50′ associated with proximity switch 48′.

Proximity switch 48′ may be configured to selectively transfer an appropriate control signal for activating electromagnetic service switch 44′ in response to a proximity sensor 50′ detecting the presence of a proximity target 68′ associated with accessory device 14′. Proximity switch 48′ may have the same general configuration as previously described with respect to proximity switch 48, and generally operates in a similar manner. Proximity switch 48′ may be operably connected to signal source 78 by means of a first control signal service line 80. Signal source 78 may be configured to generate an appropriate control signal for activating electromagnetic service switch 44′. The control signal may include an electrical signal, an acoustic or electromagnetic wave, a pneumatic signal, an optical signal, a magnetic flux signal, a radio frequency signal, an infrared (IR) signal, a hydraulic signal, a physical displacement of a linking member, as well as others. A second control signal service line 82 operably connects proximity switch 48′ to electromagnetic service switch 44′.

Coupling of accessory device 14′ to host 12′ may be accomplished in the same manner as previously described with respect to accessory device 14 and host 12. With accessory device 14′ coupled to host 12′, accessory device interface 58′ operably engages host interface 38′. The process of coupling accessory device 14′ to host 12′ further causes proximity target 68′ to engage proximity sensor 50′ and depress proximity switch 48′ as the accessory device and host are moved into engagement. Depressing proximity switch 48′ operably couples first control signal service line 80 to second control signal service line 82, thereby allowing the control signal to be transmitted from signal source 78 to electromagnetic service switch 44′. The control signal activates the electromagnetic service switch 44′ and allows the electromagnetic service to pass from electromagnetic service provider 26′ to electromagnetic service consumer 28′. Decoupling accessory device 14′ from host 12′ disengages proximity switch 48′ and interrupts the transmission of the control signal to electromagnetic service switch 44′, thereby deactivating the electromagnetic service switch.

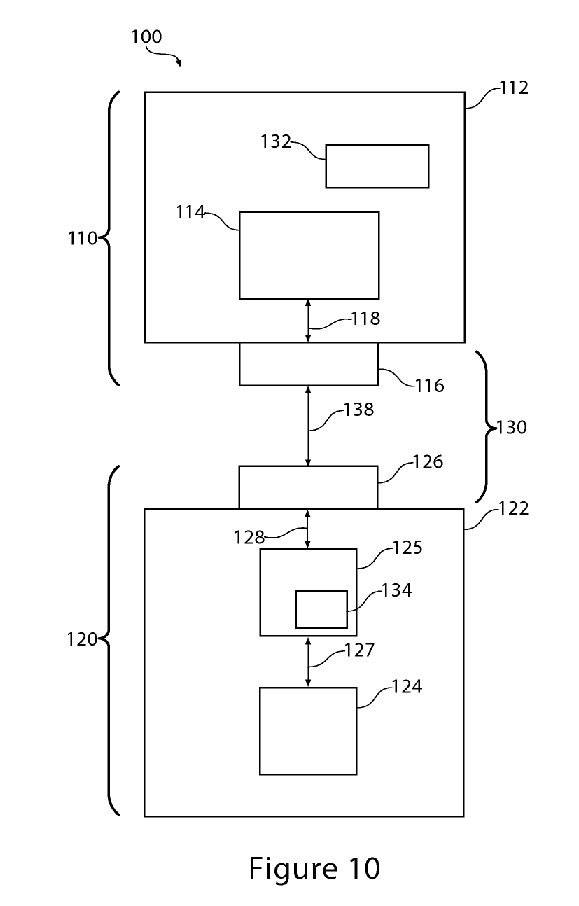

Referring to FIG. 10, a more general example of an electromagnetic service supply and consumption system 100 is schematically illustrated. A first subsystem 110 is connectable to a second subsystem 120 for selectively transferring an electromagnetic service between subsystems 110 and 120. As illustrated, first subsystem 110 may include an accessory device 112, such as a portable electronic device, including an electromagnetic service consumer 114 connected to a first electromagnetic connector component 116, such as a plug, by means of an electromagnetic service line 118. Second subsystem 120 may include a host 122, such as a refrigerator, including an electromagnetic service provider 124 connected to a second electromagnetic connector component 126, such as a receptacle, through an electromagnetic service switch 125 by electromagnetic service lines 127 and 128.

A connector system 130 includes first electromagnetic connector component 116 and second electromagnetic connector component 126, which are selectively interengageable. A proximity target 132 and a proximity switch 134, which includes a proximity sensor (not shown) for detecting the presence of proximity target 132, are respectively associated with first subsystem 110 and second subsystem 120, respectively. Proximity switch 134 is operable to selectively activate electromagnetic service switch 125 when first electromagnetic connector component 116 and second electromagnetic connector component 126 are engaged, as determined by the proximity sensor, to permit the flow of the electromagnetic service from electromagnetic service provider 124 to the second electromagnetic connector component 126, so that it may subsequently be provided along an electromagnetic service line 138 between second electromagnetic service communication component 126 and first electromagnetic service communication component 116, and then along electromagnetic service line 118 to electromagnetic service consumer 114.

It will be appreciated that while host 122 is illustrated as including an electromagnetic service provider and accessory device 112 is illustrated as including an electromagnetic service consumer, accessory device 112 may alternatively or additionally include an electromagnetic service provider and host 122 may alternatively or additionally include an electromagnetic service consumer. It will further be appreciated that while first electromagnetic connector component 116 is illustrated as being associated with electromagnetic service consumer 114 and second electromagnetic connector component 126 is illustrated as being associated with electromagnetic service provider 124, it is contemplated that first electromagnetic connector component 116 and receptacle 118 may be male or female connector components so long as the components are capable of interengaging to permit the transfer of electromagnetic service therebetween.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for illustrating certain embodiments, and should in no way be construed to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In summary, it should be understood that the invention is capable of modification and variation and is limited only by the following claims.

All defined terms used in the claims are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system for communicating between an electromagnetic service provider and an electromagnetic service consumer, the electromagnetic service consumer comprising:
an electromagnetic service connector system comprising:
a first electromagnetic service connector component capable of being operably associated with the electromagnetic service consumer and including a proximity target;
a second electromagnetic service connector component operably engageable with the first electromagnetic service connector component, the second electromagnetic service connector component being capable of being operably associated with the electromagnetic service provider;
an electromagnetic service switch operably associated with the second electromagnetic service connector component, the electromagnetic service switch selectively permitting the flow of the electromagnetic service from the electromagnetic service provider to the first electromagnetic service connector component; and
a proximity sensor operably associated with the electromagnetic service switch, the proximity sensor engageable with the proximity target when the first electromagnetic service connector component is engaged with the second electromagnetic service connector component;
wherein the electromagnetic service switch is operable to permit flow of the electromagnetic service to the first electromagnetic service connector component in response to the proximity sensor engaging the proximity target.

2. The system according to claim 1, wherein the electromagnetic service switch and the proximity sensor are integrated into a common unit.

3. The system of claim 1, wherein the proximity sensor transmits a signal to the electromagnetic service switch indicating that the first electromagnetic service connector component is engaged with the second electromagnetic service connector component.

4. The system according to claim 3, wherein the electromagnetic service switch permits flow of the electromagnetic service through the first electromagnetic service connector component in response to the signal received from the proximity sensor.

5. The system according to claim 3, wherein the signal includes at least one of an electrical signal, a pneumatic signal, an optical signal, a magnetic flux signal, a radio frequency signal, an infrared signal, and a hydraulic signal.

6. The system according to claim 1, wherein the proximity sensor comprises a proximity switch moveable between a first position when the first electromagnetic service connector component is disengaged from the second electromagnetic service connector component, and a second position when the first electromagnetic service connector component is engaged with the second electromagnetic service connector component, the electromagnetic service switch responding to movement of the proximity switch.

7. The system according to claim 4, wherein the proximity switch is biased to the first position when the first electromagnetic service connector component is disengaged from the second electromagnetic service connector component.

8. The system according to claim 7 and further comprising a link connecting the proximity switch to the electromagnetic service switch, wherein movement of the proximity switch is transmitted through the link to the electromagnetic service switch.

9. The system according to claim 1 and further comprising a host configured to communicate the electromagnetic service to the electromagnetic service consumer.

10. The system according to claim 9, wherein the host comprises at least one of a refrigerator, a freezer, a conventional oven, a microwave oven, a dishwashing machine, a stove, a range, an air conditioner, a dehumidifier, a clothes washing machine, a clothes dryer, a clothes refreshing machine, a non-aqueous washing apparatus, a water softener, a water heater, a furnace, pool water treatment equipment, an HVAC system, a thermostat, a blender, a mixer, a toaster, a coffee maker, a trash compactor, an air purifier, an iron, a vacuum cleaner, a robot, and a structural feature of a building.

11. The system according to claim 10 and further comprising an accessory device comprising the electromagnetic service consumer.

12. The system according to claim 1 and further comprising an accessory device comprising the electromagnetic service consumer.

13. The system according to claim 1, wherein the electromagnetic service comprises at least one of electrical power and data.

14. An electromagnetic service connector system for connecting electromagnetic service communicating devices, the electromagnetic service connector system comprising:
an electromagnetic service connector component capable of communicating an electromagnetic service;
an electromagnetic service switch operably connected to the electromagnetic service connector component for selectively permitting the electromagnetic service to be transmitted to the electromagnetic service connector component; and
a proximity sensor operably connected to the electromagnetic service switch and engageable with a proximity target;
wherein the electromagnetic service switch is configured to allow the electromagnetic service to be transmitted to the electromagnetic service connector component when the proximity sensor engages the proximity target.

15. The system according to claim 14, wherein the electromagnetic service switch and the proximity sensor are integrated into a common unit.

16. The system according to claim 14 and further comprising an electromagnetic service provider operably connected to the electromagnetic service switch for supplying the electromagnetic service.

17. The system of claim 14, wherein the proximity sensor transmits a signal to the electromagnetic service switch indicating that the proximity sensor is engaging the proximity target.

18. The system according to claim 17, wherein the electromagnetic service switch permits flow of the electromagnetic service to the electromagnetic service connector component in response to the signal received from the proximity sensor.

19. The system according to claim 17, wherein the signal includes at least one of an electrical signal, a pneumatic signal, an optical signal, a magnetic flux signal, a radio frequency signal, an infrared signal, and a hydraulic signal.

20. The system according to claim 14, wherein the proximity sensor comprises a proximity switch moveable between a first position when the proximity sensor is disengaged from the proximity target, and a second position when the proximity sensor is engaged with the proximity target, the electromagnetic service switch responding to movement of the proximity switch.

21. The system according to claim 20, wherein the proximity switch is biased to the first position when the proximity sensor is disengaged from the proximity target.

22. The system according to claim 21 and further comprising a link connecting the proximity switch to the electromagnetic service switch, wherein movement of the proximity switch is transmitted through the link to the electromagnetic service switch.

23. The system according to claim 14 and further comprising a host configured to communicate the electromagnetic service, wherein the host comprises at least one of a refrigerator, a freezer, a conventional oven, a microwave oven, a dishwashing machine, a stove, a range, an air conditioner, a dehumidifier, a clothes washing machine, a clothes dryer, a clothes refreshing machine, a non-aqueous washing apparatus, a water softener, a water heater, a furnace, pool water treatment equipment, an HVAC system, a thermostat, a blender, a mixer, a toaster, a coffee maker, a trash compactor, an air purifier, an iron, a vacuum cleaner, a robot, and a structural feature of a building.

24. A system for use in association with a host having an electromagnetic service provider, a first electromagnetic service connector component, and an electromagnetic service switch selectively providing an electromagnetic service to the first electromagnetic service connector component, and in association with an electromagnetic service consumer, the system comprising:
a second electromagnetic service connector component engageable with the first electromagnetic service connector component;
an electromagnetic service line interconnecting the electromagnetic service consumer and the second electromagnetic service connector component; and
a proximity target capable of engaging a proximity sensor to activate the electromagnetic service switch to enable a pathway for communicating an electromagnetic service between the first and second electromagnetic service connector components.

25. The system according to claim 24, wherein the system further comprises the electromagnetic service consumer.

26. The system according to claim 25 and further comprising a housing, wherein the electromagnetic service consumer, the electromagnetic service line and the proximity target are each at least partially disposed within the housing.

27. The system according to claim 25 and further comprising an adapter, the electromagnetic service consumer further comprising an accessory device capable of being removably coupled to the adapter.

28. The system according to claim 25, wherein the electromagnetic service consumer is at least one of a consumer electronic device, a client software device, a remote user interface, a source of consumer information, a reader, a sensor device, a smart utensil, a portable appliance, an additional smart coupling device, a remote controller, a network binder, a cycle accessory, a resource controller, a communicator, an access system, a payment system, a sales demonstration device, an electromagnetic service holder, a dispenser, a media content holder, and an electromagnetic service device.

29. The system according to claim 24, wherein the proximity target is a contact proximity target.

30. The system according to claim 25, wherein the electromagnetic service consumer is portable.

31. An adapter for removably coupling a first electromagnetic service communicating device having a first device electromagnetic service connector component to a second electromagnetic service communicating device having a first host electromagnetic service connector component that cannot be directly connected to the first device electromagnetic service connector component, and a first contact proximity coupling device, the adapter comprising:
a second host electromagnetic service connector component engageable with the first host electromagnetic service connector component;
a second device electromagnetic service connector component engageable with the first device electromagnetic service connector component;
an electromagnetic service line for the transfer of an electromagnetic service between the second host electromagnetic service connector component and the second device electromagnetic service connector component; and
a second contact proximity coupling device operably associated with the second host electromagnetic connector component;
wherein the second contact proximity coupling device is configured to engage the first contact proximity coupling device when the first and second electromagnetic connector components are engaged to selectively permit the communication of the electromagnetic service between the first electromagnetic communicating device and the second electromagnetic service communicating device.

32. The adapter according to claim 31, wherein:
the first contact proximity coupling device comprises a proximity sensor and an electromagnetic service switch selectively providing an electromagnetic service between the host electromagnetic service connector components in response to a proximity sensor engaging a proximity target; and
the second contact proximity coupling device comprises a proximity target capable of engaging the proximity sensor to actuate the electromagnetic service switch.

33. The adapter according to claim 32, wherein the proximity target engages the proximity sensor to actuate the electromagnetic service switch when the second host electromagnetic service connector component engages the first host electromagnetic service connector component.
